(19) United States
(12) Patent Application Publication
(10) Pub. No.: US 2006/0154691 A1
(43) Pub. Date: Jul. 13, 2006

(54) Architecture and protocol for software defined radio system

(75) Inventors: Liang Tang, Singapore (SG); Chang Qing Xu, Singapore (SG); Masayuki Tomisawa, Singapore (SG)

Correspondence Address: OSTROLENK FABER GERB & SOFFEN, 1180 AVENUE OF THE AMERICAS, NEW YORK, NY, 100368403, US

(73) Assignee: Oki Techno Centre (Singapore) Pte Ltd

(21) Appl. No.: 11/325,634

(22) Filed: Jan. 4, 2006

(30) Foreign Application Priority Data
Jan. 13, 2005 (SG) 200500209-2

(51) Int. Cl. H04M 1/00

(52) U.S. Cl. 455/552.1

(57) ABSTRACT

There is provided apparatus for supporting coexistence between a first wireless communication mode and a second wireless communication mode. The apparatus comprises a hardware module and a software module for implementing at least one set of protocols for both communication modes. The software module includes SDR control for enabling switching between the two communication modes. There is also provided a method for switching from the first wireless communication mode to the second wireless communication mode, in a single device, using software defined radio (SDR) control.

### FIELD OF THE INVENTION

The invention relates to an apparatus for supporting coexistence between a first wireless communication mode and a second wireless communication mode and a method for switching from the first communication mode to the second communication mode using software defined radio (SDR) control.

### BACKGROUND OF THE INVENTION

There are currently many different kinds of wireless communication standards, for example GSM (Global System for Mobile Communications), Wireless LAN (Local Area Network), Bluetooth and WCDMA (Wideband Code Division Multiple Access). The different standards are used in different applications. For example, GSM and WCDMA tend to be used in WAN (the Wide Area Network) where the data rate is low, whereas Wireless LAN (WLAN) tends to be used in LAN (the Local Area Network) where the data rate is higher.

Currently, the different wireless communication standards cannot communicate directly with one another. Therefore, it is usual for a given terminal to work with a single wireless communication mode only.

However, one wireless terminal which can work with more than one communication mode has been proposed and is illustrated in FIG. 1. This arrangement allows coexistence for Bluetooth and WLAN technologies on the same terminal. In the architecture of FIG. 1, there are three modules: 2.4 GHZ RF module 101, WLAN module 103 and Bluetooth module 105. The WLAN module 103 and the Bluetooth module 105 both include Medium Access Control (MAC) layer. There is a CPU embedded in each module, one, in WLAN module 103, for the WLAN MAC firmware and protocol, another, in Bluetooth module 105, for the Bluetooth baseband firmware and protocol. Consequently two sets of Real Time Operating Systems (RTOS) are required (one for each CPU) and there are two separate host interfaces: a WLAN Host Interface 107 and a Bluetooth Host Interface 109.

Whilst the arrangement of FIG. 1 does allow one terminal to use both Bluetooth and WLAN, because there are two sets of CPUs and associated functions, the die/PCB size is large and the memory space and the power consumption are high. In addition, the arrangement of FIG. 1 does not allow a switch from one communication mode to another to occur remotely, nor does it allow a software download (either locally or remotely).

It is an object of the invention to provide an apparatus for supporting coexistence between a first wireless communication mode and a second wireless communication mode, which mitigates or substantially overcomes the problems of known devices described above. It is a further object of the invention to provide a method for switching from a first wireless communication mode to a second wireless communication mode, in a single device, which mitigates or substantially overcomes the problems described above.

### SUMMARY OF THE INVENTION

In general terms, the invention provides apparatus for supporting coexistence between a first wireless communication mode and a second wireless communication mode. The apparatus comprises a hardware module and a software module for implementing at least one set of protocols for both communication modes. The software module includes SDR control for enabling switching between the two communication modes.

The software module may comprise a host domain and an embedded domain, as is usual with many wireless communication standards. The apparatus can work in the first communication mode, in which case data packets for the first communication mode are sent between host and embedded domains. While in the first communication mode, the software module works with hardware of the first communication mode and the processes are just like that of a standard device working in the first communication mode. When the apparatus needs to switch from the first communication mode to the second communication mode, one or more SDR control messages are sent between the host and embedded domains to instruct the mode switch and the mode switch to the second communication mode is executed in the low layer protocol. While in the second communication mode, the software module works with hardware of the second communication mode and the processes are just like that of a standard device working in the second communication mode.

In more particular terms, according to a first aspect of the invention, there is provided a software module for supporting, in a single device, coexistence between a first wireless communication mode and a second wireless communication mode, the software module comprising:

at least one set of protocols for the first communication mode;

at least one set of protocols for the second communication mode; and

software defined radio (SDR) control for enabling switching between the first communication mode and the second communication mode.

Thus, the device can operate in the first wireless communication mode or in the second wireless communication mode and the SDR control in the software module enables switching between the two modes. The at least one set of protocols for the first communication mode, may include lower layer protocol and higher layer protocol for the first communication mode.

In a preferred embodiment of the invention, the software module comprises a host domain, an embedded domain and an interface between the host domain and the embedded domain,

the host domain including: at least one upper layer protocol for the first communication mode; at least one upper layer protocol for the second communication mode; and an application and a protocol layer for the SDR control;

the embedded domain including: at least one lower layer protocol for the first communication mode; at least one lower layer protocol for the second communication mode; and a manager layer and firmware for the SDR control.

This is useful for wireless communication standards which work with a host. In that case, each one of the host domain and embedded domain preferably includes a communication layer for communicating with the other one of the host domain and embedded domain, across the interface.

The communication layers in each domain may comprise a filter for identifying incoming and outgoing data packets and a communication driver for transmitting and receiving data packets across the interface. Thus, in this case, each communication layer comprises two parts, a filter and a communication driver, each having a specific role. The role of each filter is to identify incoming and outgoing data packets appropriately. The role of each communication layer is simply to send data packets across the interface and receive data packets from across the interface.

The filter preferably forms part of the SDR control.

In an embodiment, the filter in each domain is arranged,

for outgoing data packets, to attach an identifier to the data packet for identifying the destination of the data packet, and to deliver the data packet to the communication driver for delivery across the interface; and

for each incoming data packet, to identify the destination of the data packet from its identifier, to remove the identifier and to deliver the data packet to its destination.

The identifier may be a header.

The identifier may be used to identify whether the data packet is a first communication mode data packet, a second communication mode data packet or an SDR control data packet. In one embodiment, each data packet is N×8 bits long (where N is a positive integer), including an 8-bit (1 byte) header.

Thus, in one embodiment, the filter forms part of the SDR control, which is able to send and receive data packets across the interface. Data packets for the first communication mode, for the second communication mode and for SDR control are being sent across the interface and the filter is able to distinguish between the different data packets and arrange for them to be delivered to the appropriate destination.

In one embodiment, the SDR control in the host domain is arranged to send data packets to and receive data packets from the SDR control in the embedded domain, to enable switching between the first communication mode and the second communication mode by local instruction. The data packets may be sent across the interface by the communication layers in each domain. The data packets preferably include a header (or other identifier), identifying them as SDR control data packets. Thus, the mode switch may occur within a single device.

In one embodiment, the SDR control in the host domain is arranged to send data packets to and receive data packets from a remote device to enable switching between the first communication mode and the second communication mode by remote instruction. Preferably, those data packets sent to and received from the remote device are sent by and received by the SDR protocol layer via the SDR application. In this case, the mode switch may occur by instruction from a remote device.

In one embodiment, the SDR control in the host domain is arranged to send data packets to the SDR control in the embedded domain, to upgrade software in the embedded domain. The data packets may be sent across the interface by the communication layers in each domain. The data packets preferably include a header (or other identifier), identifying them as SDR control data packets.

In that case, the SDR control in the host domain may be arranged to receive data packets from a remote device to enable the software upgrade in the embedded domain. Preferably, those data packets sent to and received from the remote device are sent by and received by the SDR protocol layer via the SDR application. In this case, the software upgrade is instructed remotely.

In a preferred embodiment of the invention, one of the first communication mode and the second communication mode is Bluetooth. In a preferred embodiment of the invention, one of the first communication mode and the second communication mode is WLAN.

In a particularly preferred embodiment of the invention, the two communication modes are Bluetooth and WLAN. Thus, the device is able to work either in Bluetooth mode (with existing standard Bluetooth devices and/or further device(s) according to the invention) or in WLAN mode (with existing standard WLAN devices and/or further device(s) according to the invention), and the SDR control allows switching between those two modes.

According to the first aspect of the invention, there is also provided apparatus for supporting coexistence between a first wireless communication mode and a second wireless communication mode, the apparatus comprising:

a hardware module;

a software module for implementing at least one set of protocols for each communication mode; and

an interface between the hardware module and the software module.

The apparatus may further comprise a memory.

In an embodiment of the invention, the software module comprises an embedded domain for implementing a first set of protocols for each communication mode and a host domain for implementing a second set of protocols for each communication mode, the second set of protocols being higher than the first set of protocols. The software module may comprise a software module as described above.

According to a second aspect of the invention, there is provided a method for switching from a first wireless communication mode to a second wireless communication mode, in a single device, using software defined radio (SDR) control, the method comprising the steps of:

a) providing a host domain including an upper layer protocol for the first communication mode, an upper layer protocol for the second communication mode and an SDR control layer;

b) providing an embedded domain including a lower layer protocol for the first communication mode, a lower layer protocol for the second communication mode and an SDR control layer;

c) sending an SDR message from the SDR control layer in the host domain to the SDR control layer in the embedded domain, the message commanding the embedded domain to switch from the first communication mode to the second communication mode; and

d) switching, in the embedded domain, from the first communication mode to the second communication mode.

Thus, the SDR control enables switching from the first communication mode to the second communication mode. Before the switch, the device operates in the first communication mode in the usual way. After the switch, the device operates in the second communication mode in the usual way.

In a preferred embodiment, the method further comprises, after step d), the step of sending an SDR message from the SDR control layer in the embedded domain to the SDR control layer in the host domain, the message indicating that the switch from the first communication mode to the second communication mode has been executed. This message confirms that the switch is complete so that the device can now operate in the second communication mode.

Preferably, the method further comprises, between steps c) and d), the step of sending an SDR message from the SDR control layer in the embedded domain to the SDR control layer in the host domain, the message indicating that the command from the SDR control layer in the host domain is accepted by the embedded domain.

Preferably, one or more of the SDR messages comprise a data packet. Advantageously, each data packet includes an identifier for identifying the packet as an SDR control packet (rather than a packet for either of the first or second communication modes). In one embodiment, the identifier is a header.

The SDR control layer in the host domain and/or in the embedded domain may be arranged to identify the appropriate destination for an incoming data packet from its identifier. The SDR control layer in the host domain and/or in the embedded domain may be arranged to add an identifier to an outgoing data packet according to its destination.

In one embodiment, the method further comprises, before step c), the step of receiving, from a remote device, an SDR message in the SDR control layer in the host domain, the message requesting a switch from the first communication mode to the second communication mode. In that case, the method may further comprise the step of sending an SDR message from the SDR control layer in the host domain to the remote device, the message indicating that the request from the remote device has been accepted. Thus, a switch from one communication mode to the other may be instructed remotely.

According to the second aspect of the invention, there is also provided a method for switching from a first wireless communication mode to a second wireless communication mode, in a single device, using software defined radio (SDR) control, the method comprising the steps of:

a) providing at least one protocol layer for each of the first and second communication modes;

b) providing software defined radio (SDR) control comprising a lower layer protocol and an upper layer protocol;

c) sending an SDR message from the SDR control upper layer to the SDR control lower layer, the message commanding the lower layer to switch from the first communication mode to the second communication mode; and

d) switching from the first communication mode to the second communication mode.

In the second aspect of the invention, the device may comprise apparatus according to the first aspect of the invention. In the second aspect of the invention, the device may comprise a software module according to the first aspect of the invention.

According to a third aspect of the invention, there is provided a method for performing, using software defined radio (SDR) control, a software upgrade in a device, the device supporting coexistence between a first wireless communication mode and a second wireless communication mode, the method comprising the steps of:

a) providing a host domain including an upper layer protocol for the first communication mode, an upper layer protocol for the second communication mode and an SDR control layer;

b) providing an embedded domain including a lower layer protocol for the first communication mode, a lower layer protocol for the second communication mode and an SDR control layer;

c) sending software upgrade data from the SDR control layer in the host domain to the SDR control layer in the embedded domain; and

d) upgrading the software.

Preferably, the method further comprises, before step c), the step of sending an SDR message from the SDR control layer in the host domain to the SDR control layer in the embedded domain, the message notifying the embedded domain of the forthcoming software upgrade. In that case, the method may further comprise the step of sending an SDR message from the SDR control layer in the embedded domain to the SDR control layer in the host domain, the message indicating that the notification from the SDR control layer in the host domain is accepted by the embedded domain.

In one embodiment, the method further comprises, after step d), the step of sending an SDR message from the SDR control layer in the embedded domain to the SDR control layer in the host domain, the message indicating that the software upgrade has been executed.

Advantageously, one or more of the SDR messages comprises a data packet. Each data packet preferably includes an identifier for identifying the packet as an SDR control packet. In one embodiment, the identifier is a header.

The SDR control layer in the host domain and/or in the embedded domain may be arranged to identify the appropriate destination for an incoming data packet from its identifier. The SDR control layer in the host domain and/or in the embedded domain may be arranged to add an identifier to an outgoing data packet according to its destination.

In one embodiment, the method further comprises, before step c), the step of receiving in the SDR control layer in the host domain, software upgrade data from a remote device.

In that embodiment, the method may further comprise, before receiving the software upgrade data from the remote device, the step of receiving in the SDR control layer in the host domain, an SDR message from the remote device, the message notifying the SDR control layer of the forthcoming software upgrade data. If that is the case, the method may further comprise the step of sending an SDR message from the SDR control layer to the remote device, the message indicating that the notification from the remote device is accepted by the SDR control layer.

In that embodiment, the method may further comprise, after receiving the software upgrade data from the remote device, the step of sending an SDR message from the SDR control layer to the remote device, the message indicating that the software upgrade data has been received.

According to the third aspect of the invention, there is also provided a method for performing, using software defined radio (SDR) control, a software upgrade in a device, the device supporting coexistence between a first wireless communication mode and a second wireless communication mode, the method comprising the steps of:

a) providing at least one protocol layer for each of the first and second communication modes;

b) providing software defined radio (SDR) control comprising a lower layer protocol and an upper layer protocol;

c) sending software upgrade data from the SDR control upper layer to the SDR control lower layer; and

d) upgrading the software.

In the third aspect of the invention, the device may comprise apparatus according to the first aspect of the invention. In the third aspect of the invention, the device may comprise a software module according to the first aspect of the invention.

According to a fourth aspect of the invention, there is provided a method for identifying the appropriate wireless communication mode to be used in a device, the device supporting coexistence between a first wireless communication mode and a second wireless communication mode, the method comprising the steps of:

a) searching for signals in the first communication mode;

b) if no signals in the first communication mode are received within a predetermined time period, switching to the second communication mode;

c) searching for signals in the second communication mode;

d) if no signals in the second communication mode are received within a predetermined time period, switching to the first communication mode; and

e) repeating steps a) to d) either until a signal is received in either the first communication mode or the second communication mode or, if no signal is received, for a predetermined number of mode switches.

In the fourth aspect of the invention, step b) of switching from the first communication mode to the second communication mode may comprise a method according to the second aspect of the invention. In the fourth aspect of the invention, step d) of switching from the second communication mode to the first communication mode may comprise a method according to the second aspect of the invention.

### BRIEF DESCRIPTION OF THE DRAWINGS

Two exemplary embodiments of the invention will now be described with reference to the accompanying drawings, of which:

FIG. 1 shows a coexistence architecture according to the prior art;

FIG. 2 shows standard Bluetooth lower layer architecture;

FIG. 3 shows standard Bluetooth upper layer architecture;

FIG. 4 shows standard WLAN lower layer architecture;

FIG. 5 shows standard WLAN upper layer architecture;

FIG. 6 shows hardware architecture according to the invention;

FIG. 7 shows software architecture according to the invention;

FIG. 8a is a diagram showing the format of an SDR command packet;

FIG. 8b is a diagram showing the format of an SDR event packet;

FIG. 8c is a diagram showing the format of an SDR data packet;

FIG. 9a is a diagram showing the format of an SDR PDU command packet;

FIG. 9b is a diagram showing the format of an SDR PDU data packet;

FIG. 10 is a flowchart of a local mode switch;

FIG. 11 is a flowchart of a remote mode switch;

FIG. 12 is a flowchart of a local software download;

FIG. 13 is a flow chart of a remote software download; and

FIG. 14 shows software architecture according to a second embodiment of the invention.

### DETAILED DESCRIPTION OF THE PREFERRED EMBODIMENTS

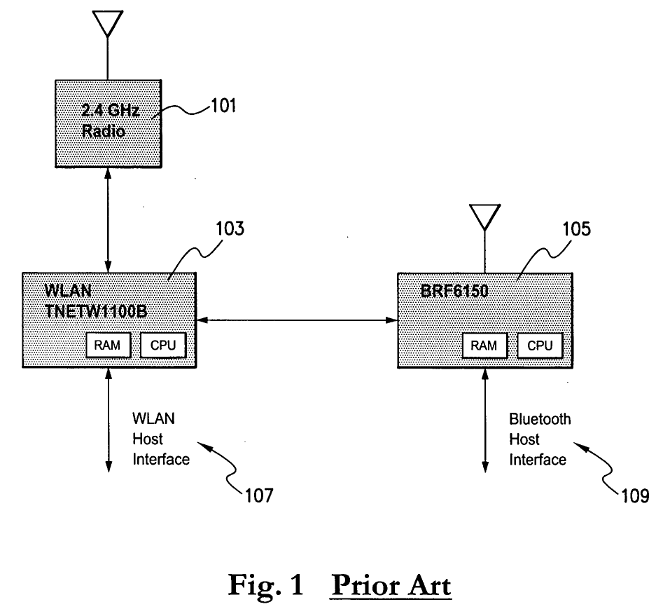

FIG. 1 illustrates an arrangement according to the prior art and has already been described.

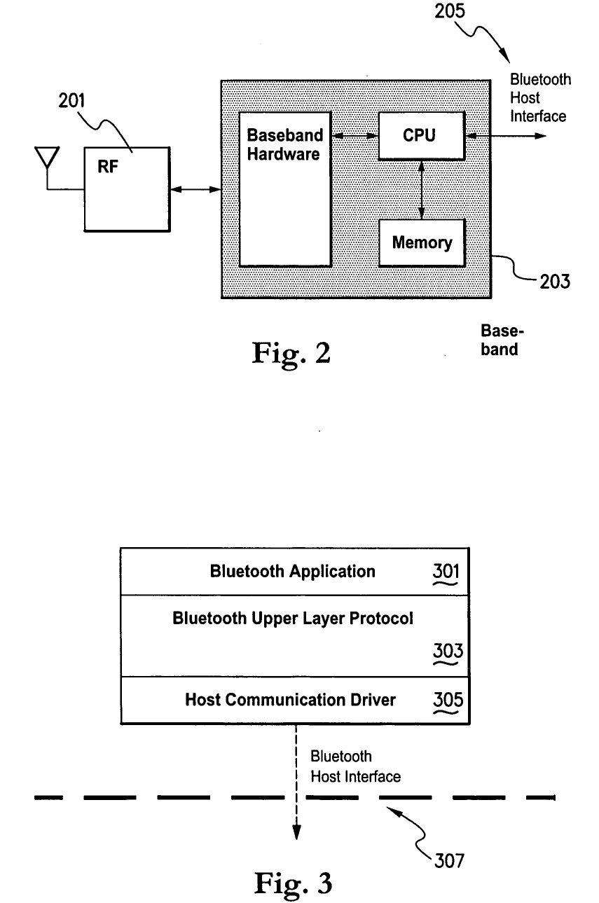

FIG. 2 shows standard Bluetooth lower layer architecture and FIG. 3 shows standard Bluetooth upper layer architecture. Referring to FIG. 2, we see that the lower layer architecture includes a standard RF module 201 and a standard Bluetooth Baseband module 203 with Bluetooth/Host Interface 205. Referring to FIG. 3, we see that the upper layer architecture includes the Bluetooth application 301 itself, the Bluetooth upper layer protocol 303 and the host communication driver 305 for communication across the Bluetooth/Host Interface 307.

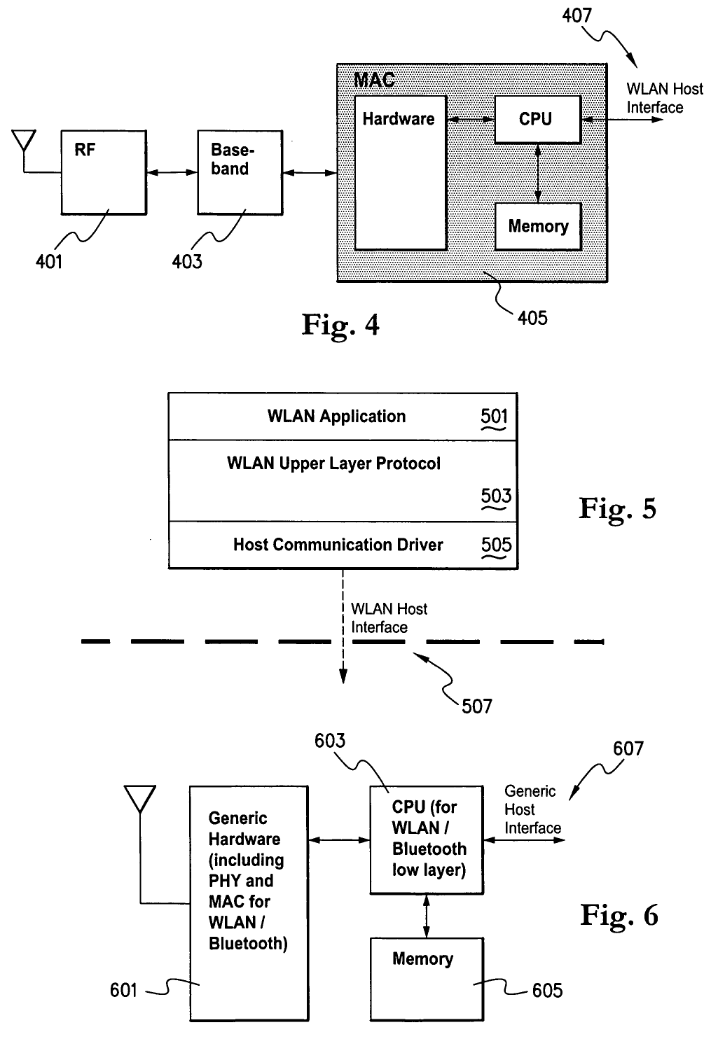

Similarly, FIG. 4 shows standard WLAN lower layer architecture and FIG. 5 shows standard WLAN upper layer architecture. Referring to FIG. 4, we see that the lower layer architecture includes standard RF and Baseband modules 401 and 403 and a standard WLAN MAC module 405 with WLAN/Host Interface 407. Referring to FIG. 5, we see that the upper layer architecture includes the WLAN application 501 itself, the WLAN upper layer protocol 503 and the host communication driver 505 for communication across the WLAN/Host Interface 507.

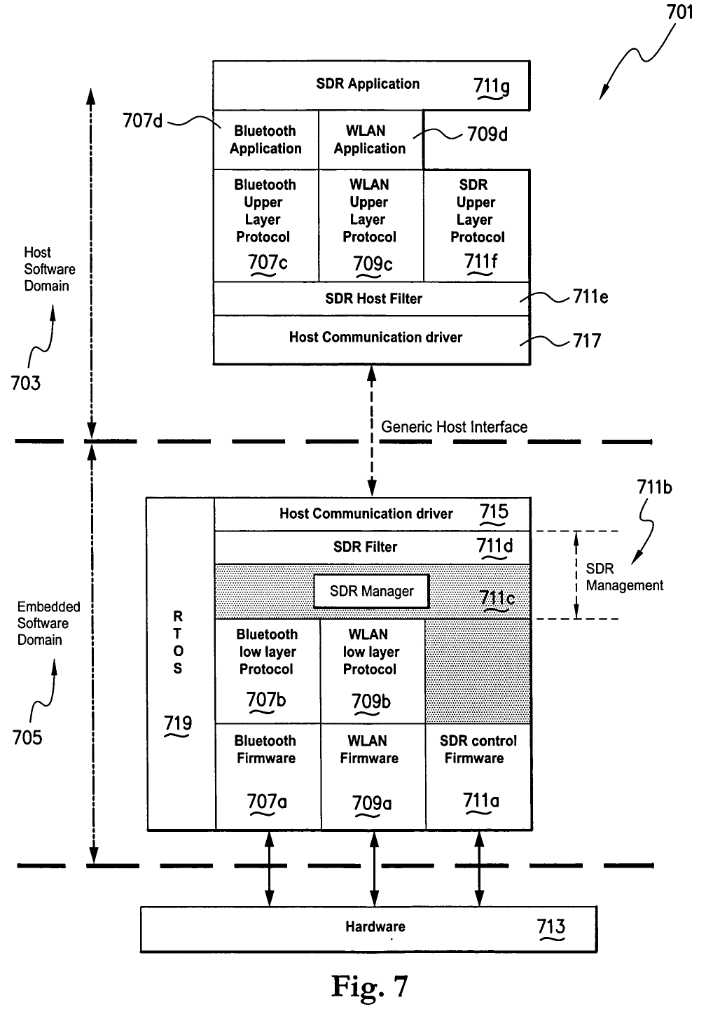

The architecture proposed by the invention is illustrated in FIGS. 6 and 7. FIG. 6 shows the hardware architecture and FIG. 7 shows the software architecture.

Referring to FIG. 6, we see that the Bluetooth and WLAN hardware have been combined together into module 601 which includes the physical (PHY) layer and those portions of the MAC layer implemented in hardware for Bluetooth and WLAN. The implementation of the hardware will be well known in the art and will not be discussed further here, although it should be noted that the combined Bluetooth/WLAN hardware can be in separate modules or in common hardware.

In the architecture shown in FIG. 6, we see that there is a single CPU 603 which will support Bluetooth, WLAN and some Software Defined Radio (SDR) functionalities. There is also a single memory 605 and a single generic host interface 607.

FIG. 7 shows the software architecture 701 proposed by the invention. It should be noted that the architecture layers are divided into two domains, which is usual for both Bluetooth and WLAN. The Bluetooth/WLAN device will work together with a host, the host implementing the upper layers, the embedded portion implementing the lower layers. The upper layers comprise the Host Software Domain 703 and the lower layers comprise the Embedded Software Domain 705.

Consider, first, the structure of the Embedded Software Domain 705, which includes Bluetooth functionality 707, WLAN functionality 709 and SDR control 711. Embedded Software Domain 705 comprises Bluetooth firmware 707a, WLAN firmware 709a and SDR control firmware 711a, together with Bluetooth low layer protocol 707b and WLAN low layer protocol 709b. The Bluetooth, WLAN and SDR control firmwares 707a, 709a and 711a communicate directly with the hardware 713.

Above the low layer protocol level is located the SDR management layer 711b, comprising the SDR manager 711c and the SDR filter 711d. The host communication driver 715 is located at the top of the Embedded Software Domain 705, for communicating with the Host Software Domain 703. All the software components will work with some RTOS, shown generally by the reference number 719.

Consider, now, the function of the various parts of the Embedded Software Domain 705. The Bluetooth firmware 707a and low layer protocol 707b (such as Link Manager protocol) are the same as in a standard Bluetooth device. Similarly, the WLAN firmware 709a and low layer protocol 709b are the same as in a standard WLAN device. The SDR control firmware 711a is responsible for the detailed SDR related functions and is located directly above the MAC hardware. This is the only portion of the software which communicates with the hardware 713 for SDR purposes.

As described, the SDR management layer 711b comprises the SDR manager 711c and the SDR filter 711d.

The SDR filter 711d receives packets from the Host Software Domain 703 via the host communication driver 715. It identifies the packet as either for the Bluetooth low layer protocol 707b, for the WLAN low layer protocol 709b or for SDR management purposes, depending on the header attached to the packet: the “SDR Header”. Once the destination has been identified from the SDR header, the SDR filter 711d strips off the SDR header and delivers the packet to its proper destination.

The SDR filter 711d also receives packets from the Bluetooth low layer protocol 707b, the WLAN low layer protocol 709b and the SDR Manager 711c, adds an appropriate header to the packet (depending on the origin of the packet) and delivers the resulting packet to the Host Software Domain 703 via the host communication driver 715.

The SDR header is 1 byte and occupies the first byte of every packet moving across the interface between the Host Software Domain 703 and the Embedded Software Domain 705 in either direction. For each wireless standard, a SDR header is defined plus a specific SDR header is defined for SDR management packets. Thus, the proper destination of a given packet can be identified by the SDR header attached to it.

The SDR manager 711c deals with SDR management which allows switching between Bluetooth and WLAN modes, software download and so on. For certain SDR functions, the SDR manager requires the support of the SDR control firmware to access the hardware. The role of the SDR manager will be discussed in more detail below.

The job of the host communication driver 715 is simply to transmit/receive packets between the Embedded Software Domain 705 and the Host Software Domain 703. The host communication driver 715 does not need to know anything about the particular communication mode being used.

Consider, now, the structure of the Host Software Domain 703, which, again, includes Bluetooth functionality, 707, WLAN functionality 709 and SDR control 711. Host Software Domain 703 comprises Bluetooth upper layer protocol 707c, WLAN upper layer protocol 709c and SDR upper layer protocol 711f, together with Bluetooth application 707d, WLAN application 709d and SDR application 711g.

Below the upper layer protocol level is the SDR host filter 711e. The host communication driver 717 is located at the bottom of the Host Software Domain 703, for communicating with the Embedded Software Domain 705.

Consider now the function of the various parts of the Host Software Domain 703. The Bluetooth and WLAN upper layer protocols 707c, 709c and applications 707d, 709d are similar to those in a standard Bluetooth or WLAN device but the upper layer protocols are based on the SDR host filter 711e rather than directly on the host communication driver. In addition, the SDR application 711g is above the Bluetooth 707d and WLAN 709d applications. The SDR application 711g has two functions: to provide a user interface (to receive user inputs and to report status or result) and to provide a data path between the SDR upper layer protocol 711f and the Bluetooth/WLAN application.

The SDR upper layer protocol 711f has two jobs. Firstly, it has to communicate with the Embedded Software Domain 705 in this device. This is done via the SDR filters 711d and 711e and host communication drivers 715 and 717, as has already been described. Secondly, it has to communicate with the SDR upper layer protocol in a second remote device.

When the SDR upper layer protocol wants to send a command to a remote SDR upper layer protocol, it does so through the SDR application 711g. The SDR application will check the current active communication mode and pass the command to the active mode's application. When the remote device receives the command, it will pass it to the SDR upper layer protocol of the remote device via the SDR application of the remote device.

The SDR host filter 711e is similar to the SDR filter 711d in the Embedded Software Domain 705. The SDR host filter 711e receives packets from the Embedded Software Domain-705 via the host communication driver 717. It identifies the packet as either for the Bluetooth upper layer protocol 707c, for the WLAN upper layer protocol 709c or for the SDR upper layer protocol 711f, depending on the SDR header attached to the packet. Once the destination has been identified from the SDR header, the SDR host filter 711e strips off the SDR header and delivers the packet to its proper destination.

The SDR host filter 711e also receives packets from the Bluetooth upper layer protocol 707c, the WLAN upper layer protocol 709c and the SDR upper layer protocol 711f, adds an appropriate header to the packet (depending on the origin of the packet) and delivers the resulting packet to the Embedded Software Domain 705 via the host communication driver 717.

Thus, with the two SDR filters 711d and 711e, Bluetooth, WLAN and SDR packets can be delivered across a single interface via host communication drivers 715 and 717. The SDR filters recognise the headers on incoming traffic and therefore send the packets to the correct destination. The SDR filters also add the appropriate headers to outgoing traffic so that the opposite SDR filter can make a correct delivery.

The job of the host communication driver 717 is simply to transmit/receive packets between the Host Software Domain 705 and the Embedded Software Domain 703. The host communication driver 717 does not need to know anything about the particular communication mode being used.

As already discussed, SDR management commands are transmitted within the local device between host and embedded domains and also between the local device and a remote device.

Consider the first case (i.e. commands transmitted within the local device). There are three kinds of management packets for the first case: SDR Command, SDR Event and SDR Data.

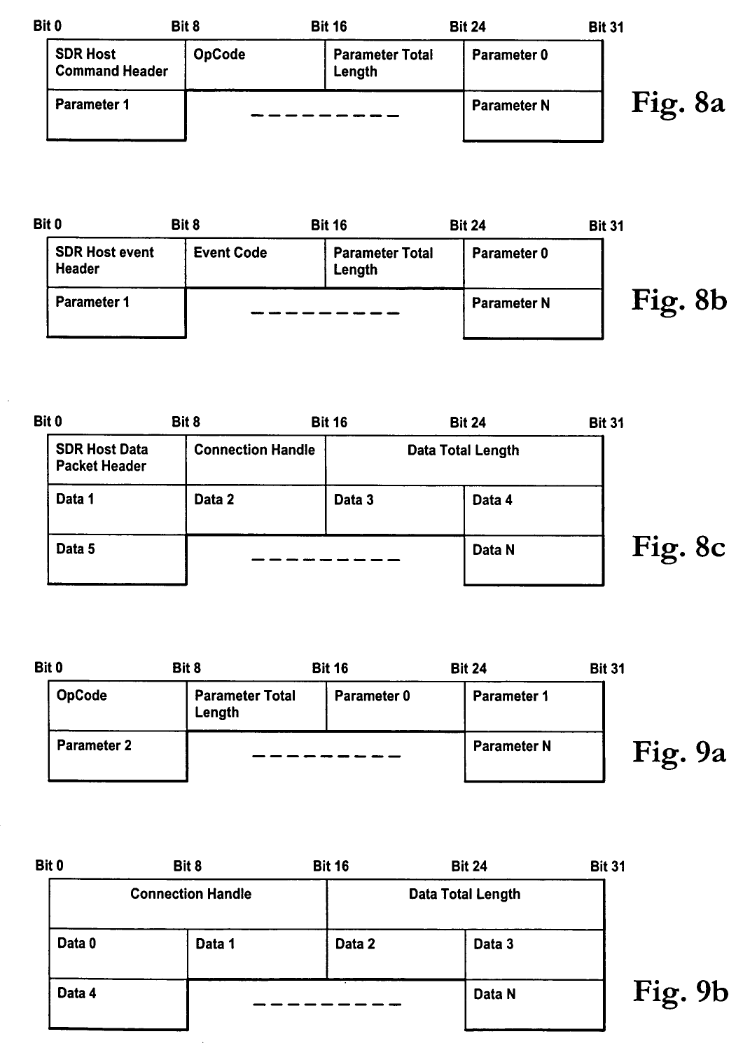

An SDR Command is transmitted from the Host Domain to the Embedded Domain to specify an SDR management command. The format of an SDR command packet is shown in FIG. 8a. The packet comprises 8×N bits. The first 8 bits (1 byte) is the SDR Host Command header identifying the packet as an SDR Command. Currently, 0x01 is defined as the SDR Command Header. The second byte is the operational code, which identifies the particular command being sent from the Host Domain to the Embedded Domain. Currently, two operational codes have been defined: 1) 0X01 which indicates the SDR_Host_Mode_Switch command 2) 0X011 which indicates the SDR_Host_SW_Download command. The SDR_Host_Mode_Switch command is sent from the Host Domain to the Embedded Domain to command the Embedded Domain to switch between communication modes i.e. from Bluetooth to WLAN or vice-versa. The SDR_Host_SW_Download command is sent from the Host Domain to the Embedded Domain to indicate that the Host Domain is going to download software. The third byte indicates the total parameter length. In the case of the SDR_Host_Mode_Switch command, the fourth portion is the “New Mode” parameter (1 byte) identifying the mode to be switched into. In the case of the SDR_Host_SW_Download, for the fourth portion there are two object parameters: Object_ROM and File_Size. For Object_ROM (1 byte), 0x00 indicates the software program will be updated (the software program will be in ROM or Flash) and 0x01 indicates the hardware program will be updated (the hardware program will be ROM and FPGA). For File_Size (4 bytes), its value indicates the length of the file to be downloaded. Of course, at the start of each SDR Command packet, an SDR Header will be added (this is not shown) to identify this packet for SDR management purposes rather than for WLAN or Bluetooth. The SDR command packets will be discussed further below.

An SDR event is transmitted from the Embedded Domain to the Host Domain to report the status or result after receipt of an SDR command. The format of an SDR event packet is shown in FIG. 8b. The packet comprises 8×N bits. The first 8 bits (1 byte) is the SDR Event header identifying the packet as an SDR Event. Currently, 0x02 is defined as the SDR Event Header. The second byte is the event code, which identifies the particular result or status being reported to the Host Domain from the Embedded Domain. Currently, two event codes have been defined: 1) 0x01 which indicates the SDR_Host_Command_Status event and 2) 0x02 which indicates the SDR_Host_Command_Complete event. The SDR_Host_Command_Status event is sent from the Embedded Domain to the Host Domain in response to a SDR_Host_Mode_Switch command or a SDR_Host_SW_Download command. The Embedded Domain is indicating either that it is ready to switch between communication modes (in the case of a SDR_Host_Mode_Switch command) or that it is ready for a software download (in the case of a SDR_Host_SW_Download command). The SDR_Host_Command_Complete event is sent from the Embedded Domain to the Host Domain to indicate a particular command execution result. The Embedded Domain is indicating either that it has completed a switch between communication modes (in the case of a SDR_Host_Mode_Switch command) or that it has received the software download data and updated the ROM or Flash or FPGA with the received data (in the case of a SDR_Host_SW_Download command). Of course, at the start of each SDR Event packet, an SDR Header will be added (this is not shown) to identify that the packet is for SDR management purposes rather than for WLAN or Bluetooth. The SDR event packets will be discussed further below.

SDR Data will be transmitted from the Host Domain to the Embedded Domain or from the Embedded Domain to the Host Domain. The format of an SDR Data packet is shown in FIG. 8c. The packet comprises 8×N bits. The first byte is the SDR Host Data header identifying the packet as an SDR Data packet. Currently, 0x03 is defined as the SDR Host Header. The second byte is the Connection Handle parameter. The third and fourth bytes are the Data Total Length parameter, which specify the SDR data packet's length. The remainder of the packet is the payload. Of course, at the start of each SDR Command packet, an SDR Header will be added (this is not shown) to identify this packet for SDR management purposes rather than for WLAN or Bluetooth.

Now, consider the second case (i.e. commands transmitted between the local device and a remote device). To distinguish this type of packets from the SDR packets transmitted within the local device (and described above), we shall refer to these packets as SDR PDU packets. (PDU refers to Protocol Data Unit.) There are two kinds of SDR PDU packets: SDR PDU command and SDR PDU data.

An SDR PDU command is transmitted from the SDR upper layer protocol of a local device to the SDR upper layer protocol of a remote device, via the SDR application. The format of an SDR PDU command packet is shown in FIG. 9a. The packet comprises 8×N bits, the first 8 bits being the operational code, which identifies the particular command being sent from one device to the other. (Note that there is no need for an SDR header for SDR PDU packets because the packet is being delivered between two separate devices rather than between the host and embedded portions of a single device. In fact, for sending a SDR PDU packet, the SDR upper layer 711f will pass the SDR PDU packet to the active communication mode's application 707d or 709d via the SDR application 711g. Then the SDR PDU packet will be composed as a normal Bluetooth or WLAN packet and it will be passed to the embedded domain 705. As a Bluetooth or WLAN packet (although its content is actually the SDR PDU packet), it will be given a header, indicating Bluetooth or WLAN, at the interface between the two communication drivers 717 and 715. The process for receiving a SDR PDU packet is exactly the opposite.) Currently, five operational codes have been defined: 1) 0x08 which indicates the SDR_PDU_Mode_Switch_req command; 2) 0x09 which indicates the SDR_PDU_SW_Download_req command; 3) 0x01 which indicates the SDR_PDU_accept command; 4) 0x02 which indicates the SDR_PDU_not_accept command; and 5) 0x0A which indicates the SDR_PDU_SW_Download_check command. The first two operational codes and the last operational code are sent from a first device to a second device and operational codes 3) and 4) are sent in the opposite direction. The SDR_PDU_Mode_Switch_req command is sent from a first device to a second device to request that the communication mode be switched. The SDR_PDU_accept command or the SDR_PDU_not_accept command is sent back from the second device to the first device to either accept or decline the request for a switch in communication modes. The SDR_PDU_SW_Download_req command is sent from a first device to a second device to indicate that the first device wants to download software to the second device. The SDR_PDU accept command or the SDR_PDU_not_accept command is sent back from the second device to the first device to either accept or decline the request for a software download. The SDR_PDU_SW_Download_check command is sent from the first device to the second device to give some verification information and the second device will send back SDR_PDU_accept or SDR_PDU_not_accept to indicate whether it received all the data. The SDR PDU command packets will be discussed in more detail below.

SDR PDU Data will be transmitted between host domains of two remote devices to load data for a software download. The format of an SDR PDU Data packet is shown in FIG. 9b. (Once again, note that there is no need for an SDR header as the packet is being delivered between two separate devices rather than between the host and embedded portions of a single device.)

Operation of the architecture of FIGS. 6 and 7 will now be described. As should already be appreciated, the system can work in Bluetooth mode or WLAN mode. The system can switch between the two modes easily by virtue of the SDR management. Software can also be downloaded, either locally or remotely. If a remote device enables the same architecture and protocol, the local device can send SDR requirements to the remote device for mode switching and software upgrade. Three modes of operation will now be described:

Switching between modes

Downloading software, and

Identifying the correct mode.

1) Switching Between Modes

At any one time, there is only one active communication mode in the Embedded Software Domain. In Bluetooth mode, the Bluetooth low layer protocol and the Bluetooth firmware exist but the WLAN low layer protocol and the WLAN firmware do not exist. Conversely, in WLAN mode, the WLAN low layer protocol and the WLAN firmware exist but the Bluetooth low layer protocol and the Bluetooth firmware do not exist.

Suppose the device is working in Bluetooth communication mode. The SDR application sets the Bluetooth mode active and the WLAN mode inactive. All the WLAN tasks are terminated by the RTOS. Normal Bluetooth commands and data will be passed from the Host Domain 703 to the Embedded Domain 705 via the host interface. The packets passing across the interface include an SDR header, which header identifies the packet as a Bluetooth packet. Therefore, when the SDR filter 711d receives incoming packets, it can identify, from the SDR header, that the packets are for Bluetooth usage and, after stripping off the SDR header, can deliver the packets to Bluetooth low layer protocol 707b. After that, the process is just the same as normal Bluetooth operation.

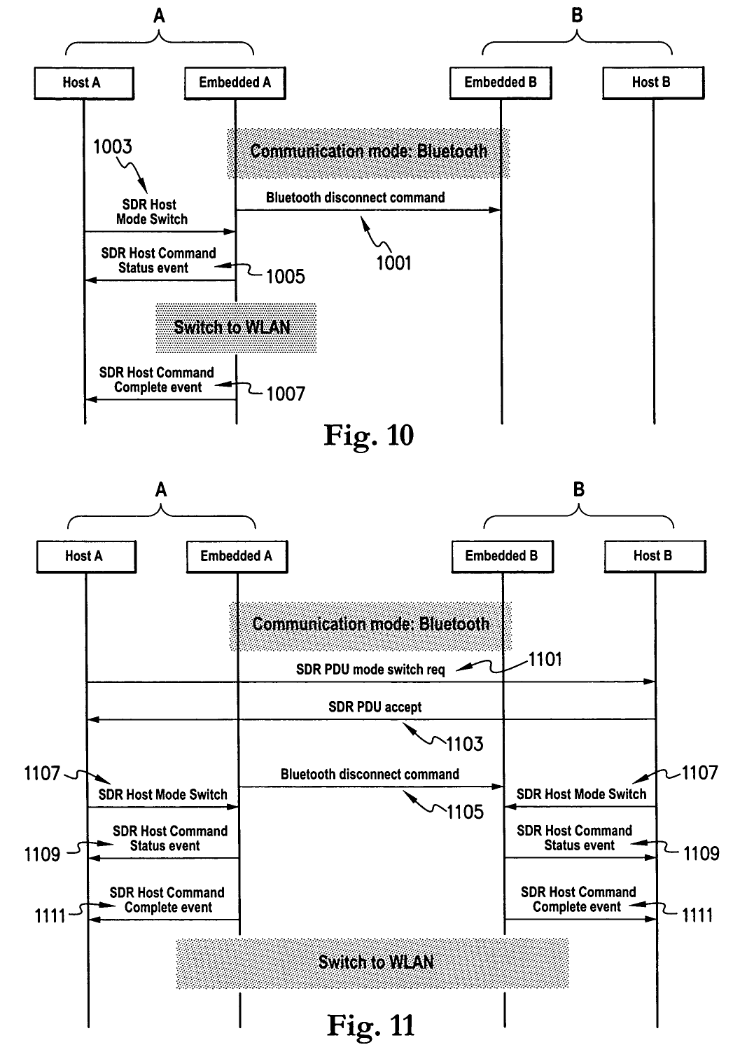

FIG. 10 is a flow chart showing the steps taken when a user switches from Bluetooth mode to WLAN mode i.e. a local mode switch. Two devices A and B, each including host and embedded domains, are communicating in Bluetooth mode. When the user of device A wants to switch mode, the Bluetooth communication will be disconnected at first (step 1001), and then the SDR upper layer protocol will send a SDR_Host_Mode_Switch command to the Embedded Domain (step 1003) to indicate that a mode switch is required. The format of the SDR command packet includes an SDR header (see FIG. 8a) so the SDR filter 711d will know to pass the command to the SDR manager 711c, rather than the Bluetooth low layer protocol 707b. Then the SDR manager will send a SDR_Host_Command_Status event to the Host Domain (step 1005) to indicate whether the Embedded Domain will perform the switch between Bluetooth mode and WLAN mode. If the Embedded Domain does not agree to perform the mode switch, the following procedures will not be commenced. If the Embedded Domain does agree to perform the mode switch, then the SDR manager 711c will ask the SDR control firmware 711a to switch the hardware from Bluetooth mode to WLAN mode. Then the SDR manager will terminate all Bluetooth tasks and commence WLAN tasks. Thus, the Embedded Domain is now changed to WLAN mode. After mode switching is complete, the SDR manager will send a SDR_Host_Command_Complete event to the Host Domain (step 1007) to indicate that the mode switching has been completed. If there is a problem during the mode switch, the event will specify the error reason.

Thus, the device is now working in WLAN communication mode, rather than Bluetooth. The SDR application sets the WLAN mode active and the Bluetooth mode inactive. All the Bluetooth tasks are terminated by the RTOS. Normal WLAN commands and data will be passed from the Host Domain 703 to the Embedded Domain 705 via the host interface. The packets passing across the interface include an SDR header, which header identifies the packet as a WLAN packet. Therefore, when the SDR filter 711d receives incoming packets, it can identify, from the SDR header, that the packets are for WLAN usage and, after stripping off the SDR header, can deliver the packets to WLAN low layer protocol 709b. After that, the process is just the same as normal WLAN operation.

FIG. 11 is a flow chart showing the steps taken when local and remote devices switch mode together i.e. a remote mode switch. As with FIG. 10, two devices A and B, each including Host and Embedded Domains, are communicating in Bluetooth mode. When devices A and B want to switch to a new mode together, SDR PDU packets will be used to send commands between the two devices' SDR upper layer protocols and, hence, commence the switch. The SDR upper layer protocol of Host A will send a SDR_PDU_Mode_Switch_req command to the SDR upper layer protocol of Host B (step 1101). Since operation is currently in Bluetooth mode, this command will be sent in Bluetooth mode. If Host B agrees to do the mode switch, the SDR upper layer protocol of Host B will send a SDR_PDU_accept command (in Bluetooth mode) to the SDR upper layer protocol of Host A (step 1103). If Host B does not agree to do the mode switch, the following procedures will not be commenced.

At that stage, the steps will be just like that in the local mode switch i.e. a Bluetooth disconnect command will be sent between devices (step 1105) and then, in each device, the SDR_Host_Mode_Switch will be sent from Host Domain to Embedded Domain (step 1107). Then each Embedded Domain will return a SDR_Host_Command_Status event to its respective Host Domain (step 1109). Then, after completing the mode switch, each Embedded Domain will send a SDR_Host_Command_Complete event to its respective Host Domain (step 1111). From then on, the two devices will switch to WLAN and can communicate in WLAN mode.

2) Downloading Software

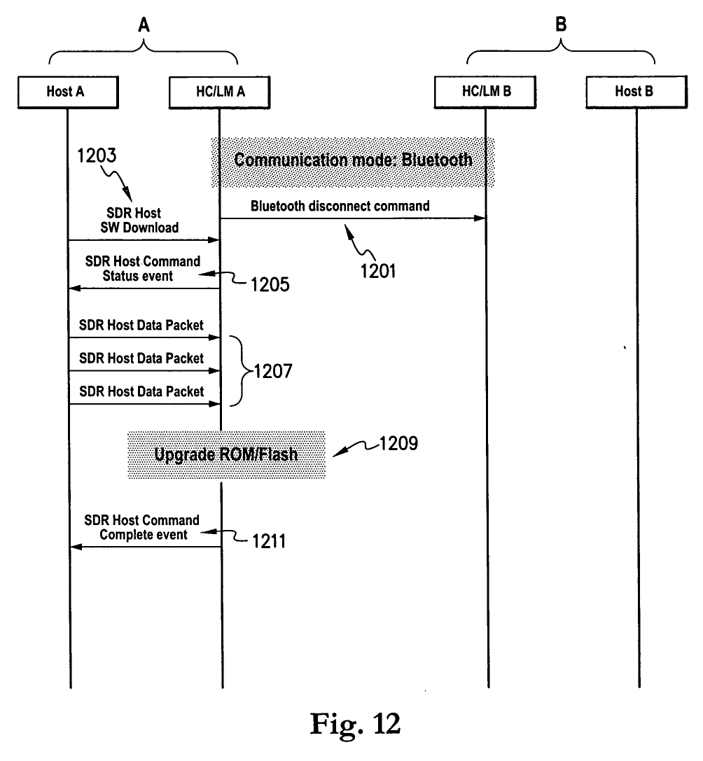

The software of the Embedded Domain (including hardware FPGA data is there is FPGA in hardware) can be updated and FIG. 12 is a flow chart showing the procedure for a software download from a local user i.e. a local software download. Such a software download can also take place even if the devices can only communicate in a single mode.

Two devices, A and B, each including Host and Embedded Domains, are communicating in Bluetooth mode. When the user of device A wants to update the software in A's Embedded Software Domain, a Bluetooth disconnect command will be sent between devices (step 1201). Then, the SDR upper layer protocol will send a SDR_Host_SW_Download command to the Embedded Domain (step 1203) to indicate that a software download is required. The format of the SDR command packet includes an SDR header (see FIG. 8a) so the SDR filter 711d will know to pass the command to the SDR manager 711c, rather than the Bluetooth low layer protocol 707b. Then, the SDR manager will send a SDR_Host_Command_Status event to the Host Domain (step 1205) to indicate whether the Embedded Domain is ready for a software download. After sending this event to the Host Domain, the Embedded Domain will wait for the software download. On receiving the SDR_Host_Command_Status event, the Host Domain will send a plurality of SDR data packets to the Embedded Domain (step 1207), the data packets comprising the necessary software upgrade data. The Embedded Domain will store the SDR data packets' payloads in its memory. Once all the SDR data packets are received (which can be determined by checking the data length), the SDR manager will request the SDR control firmware to update the ROM/Flash or FPGA depending on the SDR_Host_SW_Download command's object_ROM parameter. This is shown at step 1209. Once the upgrade procedure is complete, the SDR manager will send a SDR_Host_Command_Complete event to the Host Domain (step 1211) to indicate that the software download is complete. If there is a problem with the software download, this event will give the error reason.

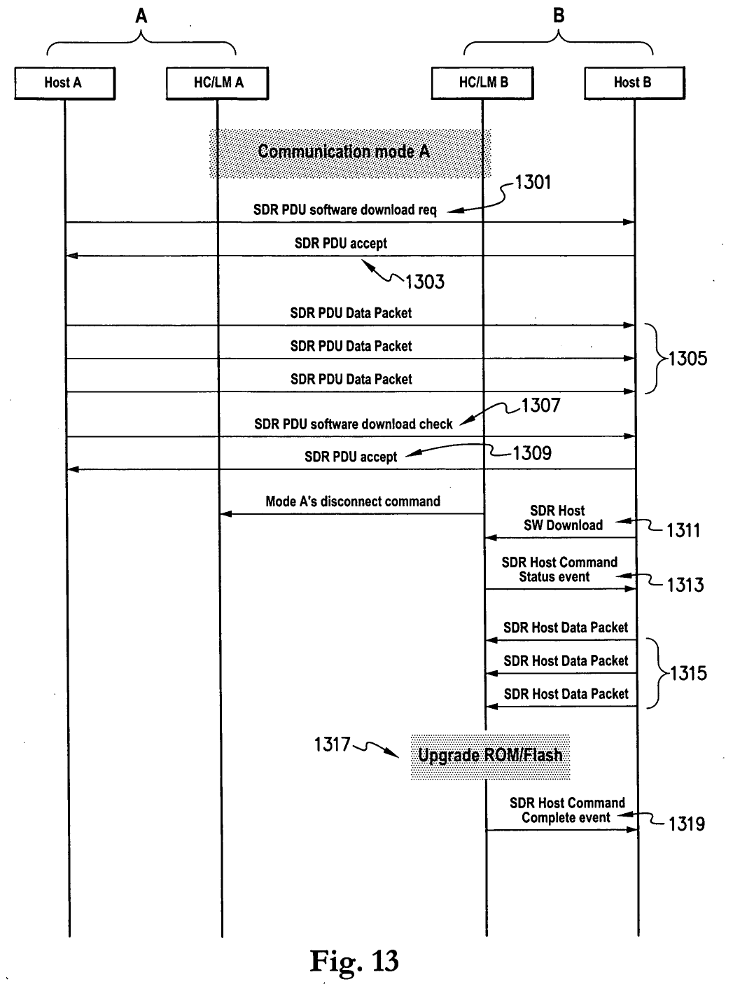

FIG. 13 is a flowchart showing the procedure for a software download for a remote device i.e. a remote software download.

Two devices, A and B, each including Host and Embedded Domains, are communicating in communication mode A. When the user of device A wants to update the software in B's Embedded Software Domain, SDR PDU packets will be used to send commands between the two devices' SDR upper layer protocols. Host A's SDR upper layer protocol will send a SDR_PDU_SW_Download_req to Host B's SDR upper layer protocol (step 1301). Since operation is currently in communication mode A, the command will be sent in that mode. If Host B agrees to the software download, Host B's SDR upper layer protocol will send a SDR_PDU_accept command to Host A's SDR upper layer protocol (step 1303). After sending this message to Host A, Host B will wait for the software download. On receiving the SDR_PDU_accept message, Host A will send a plurality of data packets to Host B (step 1305), the data packets comprising the necessary software upgrade data. If the upgrading data is large, Host A may need to send many data packets.

Once Host A has sent all the upgrading data to Host B, it will send a SDR_PDU_SW_Download_check command to Host B (step 1307). Host B will send back a SDR_PDU_accept message (step 1309) if the received data size is equal to the SDR_PDU_SW_Download_req command's File_Size parameter. (Otherwise, Host B will send back a SDR_PDU_not_accept message and the following procedures will not be commenced.)

At that stage, the steps will be just like that in the local software download i.e. at first, B will disconnect the current communication then B's SDR upper layer protocol will send a SDR_Host_SW_Download command to the B's Embedded Domain (step 1311) to indicate that a software download is required. Then, B's SDR manager will send a SDR_Host_Command_Status event to B's Host Domain (step 1313) to indicate that the Embedded Domain is ready for a software download. Then, B's Host Domain will send a plurality of SDR data packets to the Embedded Domain (step 1315), the data packets comprising the necessary software upgrade data. Once all the SDR data packets are received, B's SDR manager will request the SDR control firmware to update the ROM/Flash or FPGA depending on the SDR_Host_SW_Download command's object_ROM parameter. This is shown at step 1317. Once the upgrade procedure is complete, B's SDR manager will send a SDR_Host_Command_Complete event to B's Host Domain (step 1319) to indicate that the software download is complete.

3) Mode Identification

The proposed system detects the available wireless signal to determine which kind of communication mode will be active.

Suppose the default communication mode is Bluetooth. In that case, after power on, the Embedded Domain will set the hardware into Bluetooth mode and begin Bluetooth tasks in software. As already mentioned, only one communication mode is active at a time. Therefore no WLAN tasks will commence. SDR application will ask Bluetooth application to search for Bluetooth signal. Bluetooth application and Bluetooth upper layer will ask Embedded Domain to search other Bluetooth devices (for example by Bluetooth inquiry procedure).

If there is a response, the device will remain in Bluetooth mode. If no response is received (within a given time period), a mode switch to WLAN will occur (by the steps described with reference to FIG. 10). Then SDR application will ask WLAN application to search for WLAN signal. As with the Bluetooth procedure, if no response is found, within the given time period, the system will switch back to Bluetooth. Thus, if no response is found, the device will switch between modes, searching for a signal each time. After a prescribed number of mode switches, the system will return to its default mode, in this case, Bluetooth. On the other hand, if a response is found, the system will remain in that mode.

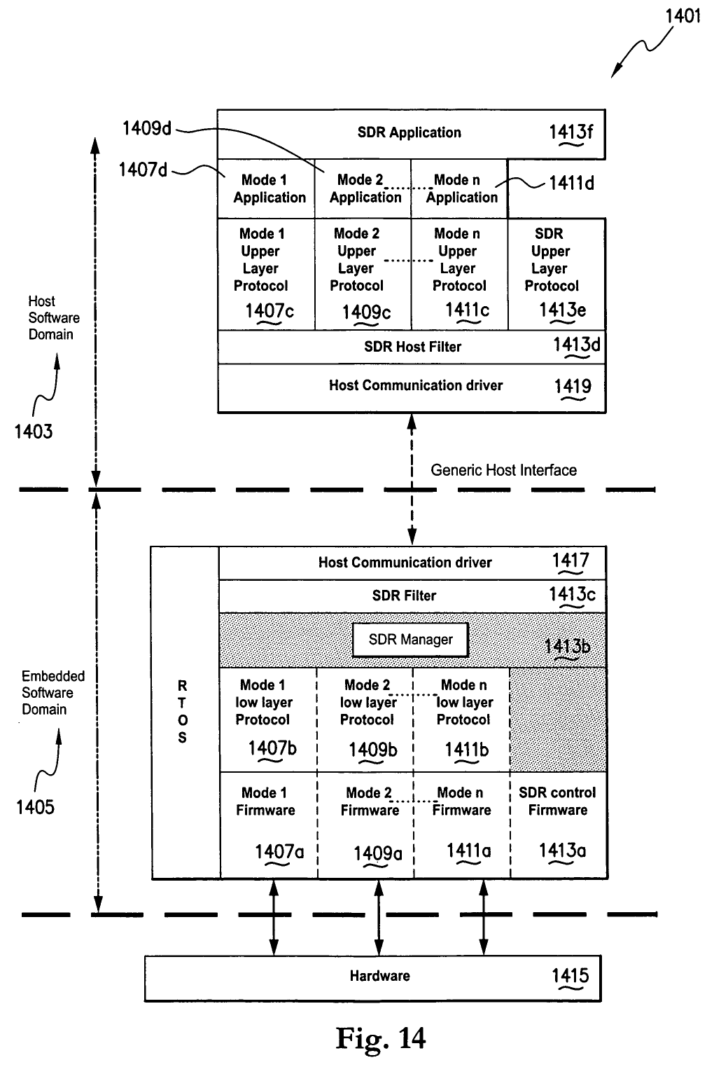

The skilled person will appreciate that the invention of the present application is not restricted to Bluetooth and WLAN communication only. In fact, the invention can be used with any type and number (n) of wireless standards and FIG. 14 shows the proposed solution. As with FIG. 7, the architecture 1401 is divided into two domains, Host Domain 1403 and Embedded Domain 1405. Embedded Domain 1405 comprises firmware and low layer protocol for n communication modes and SDR control firmware 1413a. Host Domain 1403 comprises upper layer protocol and application for n modes and SDR upper layer protocol 1413e and application 1413f. Like FIG. 7, Embedded Domain also includes an SDR manager 1413b, an SDR filter 1413c and a host communication driver and Host Domain includes a host communication driver 1419 and SDR host filter 1413d.

FIG. 14 shows the case if any communication standards need to be divided into Embedded Domain and Host Domain. If all the n communication standards need not be divided as Embedded System and host system, FIG. 14 will be slightly changed: the SDR host filter, SDR filter and host communication drives will be deleted and the two domains will merge together. An SDR header will not be necessary, as packets in the different communication modes can be identified and distinguished in a single CPU. Operation of the merged case will be the same as that of the two-domain case.

The overall operation of the FIG. 14 case will not be described in detail as it will be understood that operation is essentially the same as that previously described in detail, with reference to Bluetooth and WLAN. However, a few general points will be made.

At any one time, the system will operate in a single communication mode only. That communication mode will be set active whilst the other n−1 communication modes will be set inactive. The SDR filter and SDR host filter can identify the packets crossing the interface and deliver them as appropriate. The SDR upper layer protocol will manage the local SDR capability and communicate with the SDR upper layer protocol of a remote device. The SDR management packets and SDR PDU packets are identical to those of the Bluetooth/WLAN case already described. Mode switch, software download, and mode identification are all supported.

It will be seen from the previous description of the invention that the proposed system can support multiple communication modes by using different communication modes' firmware, low layer protocol, upper layer protocol and application off-the-shelf with no or slight modification. Only one embedded CPU is used and the gate count, power consumption, size and memory usage are reduced compared with known arrangements. A single wireless terminal can be used for multiple mode communication and seamless switching between modes.

1. A software module for supporting, in a single device, coexistence between a first wireless communication mode and a second wireless communication mode, the software module comprising:
at least one set of protocols for the first communication mode;
at least one set of protocols for the second communication mode; and
software defined radio (SDR) control for enabling switching between the first communication mode and the second communication mode.

2. A software module according to claim 1, comprising a host domain, an embedded domain and an interface between the host domain and the embedded domain,
the host domain including:
at least one upper layer protocol for the first communication mode;
at least one upper layer protocol for the second communication mode; and
an application and a protocol layer for the SDR control;
the embedded domain including:
at least one lower layer protocol for the first communication mode;
at least one lower layer protocol for the second communication mode; and
a manager layer and firmware for the SDR control.

3. A software module according to claim 2, wherein each one of the host domain and embedded domain includes a communication layer for communicating with the other one of the host domain and embedded domain, across the interface.

4. A software module according to claim 3, wherein the communication layers in each domain comprise a filter for identifying incoming and outgoing data packets and a communication driver for transmitting and receiving data packets across the interface.

5. A software module according to claim 4, wherein the filter in each domain is part of the SDR control.

6. A software module according to claim 4, wherein the filter in each domain is arranged,
for each outgoing data packet, to attach an identifier to the data packet for identifying the destination of the data packet, and to deliver the data packet to the communication driver for delivery across the interface; and
for each incoming data packet, to identify the destination of the data packet from its identifier, to remove the identifier and to deliver the data packet to its destination.

7. A software module according to claim 6, wherein the identifier is a header.

8. A software module according to claim 6, wherein the identifier is arranged to identify whether the data packet is a first communication mode data packet, a second communication mode data packet or an SDR control data packet.

9. A software module according to claim 2, wherein the SDR control in the host domain is arranged to send data packets to and receive data packets from the SDR control in the embedded domain, to enable switching between the first communication mode and the second communication mode.

10. A software module according to claim 9, wherein the SDR control in the host domain is arranged to send data packets to and receive data packets from a remote device to enable switching between the first communication mode and the second communication mode.

11. A software module according to claim 10, wherein data packets sent to and received from the remote device are sent by and received by the SDR protocol layer via the SDR application.

12. A software module according to claim 2, wherein the SDR control in the host domain is arranged to send data packets to the SDR control in the embedded domain, to upgrade software in the embedded domain.

13. A software module according to claim 12, wherein the SDR control in the host domain is arranged to receive data packets from a remote device to enable the software upgrade in the embedded domain.

14. A software module according to claim 1 wherein one of the first communication mode and the second communication mode is Bluetooth.

15. A software module according to claim 1 wherein one of the first communication mode and the second communication mode is WLAN.

16. Apparatus for supporting coexistence between a first wireless communication mode and a second wireless communication mode, the apparatus comprising:
a hardware module;
a software module for implementing at least one set of protocols for each communication mode; and
an interface between the hardware module and the software module.

17. Apparatus according to claim 16, further comprising a memory.

18. Apparatus according to claim 16, wherein the software module comprises an embedded domain for implementing a first set of protocols for each communication mode and a host domain for implementing a second set of protocols for each communication mode, the second set of protocols being higher than the first set of protocols.

19. Apparatus according to claim 16, wherein the software module comprises a software module according to claim 1.

20. A method for switching from a first wireless communication mode to a second wireless communication mode, in a single device, using software defined radio (SDR) control, the method comprising the steps of:
a) providing a host domain including an upper layer protocol for the first communication mode, an upper layer protocol for the second communication mode and an SDR control layer;
b) providing an embedded domain including a lower layer protocol for the first communication mode, a lower layer protocol for the second communication mode and an SDR control layer;
c) sending an SDR message from the SDR control layer in the host domain to the SDR control layer in the embedded domain, the message commanding the embedded domain to switch from the first communication mode to the second communication mode; and
d) switching, in the embedded domain, from the first communication mode to the second communication mode.

21. A method according to claim 20, further comprising, after step d), the step of sending an SDR message from the SDR control layer in the embedded domain to the SDR control layer in the host domain, the message indicating that the switch from the first communication mode to the second communication mode has been executed.

22. A method according to claim 20, further comprising, between steps c) and d), the step of sending an SDR message from the SDR control layer in the embedded domain to the SDR control layer in the host domain, the message indicating that the command from the SDR control layer in the host domain is accepted by the embedded domain.

23. A method according to claim 20, wherein one or more of the SDR messages comprise a data packet.

24. A method according to claim 23, wherein the data packet includes an identifier for identifying the packet as an SDR control packet.

25. A method according to claim 24, wherein the SDR control layer in the host domain and/or in the embedded domain is arranged to identify the appropriate destination for an incoming data packet from its identifier.

26. A method according to claim 24, wherein the SDR control layer in the host domain and/or in the embedded domain is arranged to add an identifier to an outgoing data packet according to its destination.

27. A method according to claim 20, further comprising, before step c), the step of receiving, from a remote device, an SDR message in the SDR control layer in the host domain, the message requesting a switch from the first communication mode to the second communication mode.

28. A method according to claim 27, further comprising the step of sending an SDR message from the SDR control layer in the host domain to the remote device, the message indicating that the request from the remote device has been accepted.

29. A method for performing, using software defined radio (SDR) control, a software upgrade in a device, the device supporting coexistence between a first wireless communication mode and a second wireless communication mode, the method comprising the steps of:
a) providing a host domain including an upper layer protocol for the first communication mode, an upper layer protocol for the second communication mode and an SDR control layer;
b) providing an embedded domain including a lower layer protocol for the first communication mode, a lower layer protocol for the second communication mode and an SDR control layer;
c) sending software upgrade data from the SDR control layer in the host domain to the SDR control layer in the embedded domain; and
d) upgrading the software.

30. A method according to claim 29, further comprising, before step c), the step of sending an SDR message from the SDR control layer in the host domain to the SDR control layer in the embedded domain, the message notifying the embedded domain of the forthcoming software upgrade.

31. A method according to claim 30, further comprising the step of sending an SDR message from the SDR control layer in the embedded domain to the SDR control layer in the host domain, the message indicating that the notification from the SDR control layer in the host domain is accepted by the embedded domain.

32. A method according to claim 29, further comprising, after step d), the step of sending an SDR message from the SDR control layer in the embedded domain to the SDR control layer in the host domain, the message indicating that the software upgrade has been executed.

33. A method according to claim 29, wherein one or more of the SDR messages comprise a data packet.

34. A method according to claim 33, wherein the data packet includes an identifier for identifying the packet as an SDR control packet.

35. A method according to claim 34, wherein the SDR control layer in the host domain and/or in the embedded domain is arranged to identify the appropriate destination for an incoming data packet from its identifier.

36. A method according to claim 34, wherein the SDR control layer in the host domain and/or in the embedded domain is arranged to add an identifier to an outgoing data packet according to its destination.

37. A method according to claim 29 further comprising, before step c), the step of receiving in the SDR control layer in the host domain, software upgrade data from a remote device.
